(19) United States
(12) Patent Application Publication
(10) Pub. No.: US 2015/0012336 A1
(43) Pub. Date: Jan. 8, 2015

(54) ASSESSING IMPACT OF COMMUNICATIONS BETWEEN SOCIAL NETWORKING SYSTEM USERS ON A BRAND

(71) Applicant: Facebook, Inc., Menlo Park, CA (US)

(72) Inventors: Frederick Ross Leach, San Francisco, CA (US); Sean Michael Bruich, Palo Alto, CA (US)

(21) Appl. No.: 13/933,598

(22) Filed: Jul. 2, 2013

(51) Int. Cl. G06Q 50/00; G06Q 30/02

(52) U.S. Cl. CPC G06Q 50/01; G06Q 30/0201
USPC 705/7.33; 705/7.29

(57) ABSTRACT

A social networking system identifies communications about an object associated with a brand owner. For each communication, the social networking system identifies users who were generated the communication, users who were exposed to the communication, and users who were not exposed to the communication. The social networking system measures the impact of the communications on the behavior and/or sentiment of the users towards the brand owner. For example, the social networking system presents users with surveys after presentation of a communication about an object associated with a brand owner and determines the impact of the communication from the responses to the survey. The impact of the communications may then be reported to the brand owner.

### BACKGROUND

This invention relates generally to social networking systems, and in particular to monitoring communications on a social networking system.

Social networking systems allow users to connect to and communicate with other users of the social networking system. Users create profiles on the social networking system that are tied to their identities and include information about the users, such as interests and demographic information. The users may be individuals or entities such as corporations or charities. Because of the increasing popularity of social networking systems and the significant amount of user-specific information maintained by social networking systems, a social networking system presents an ideal forum for users to share their interests and experiences with each other by posting content on the social networking system that may be viewed by additional users. This also allows a business or brand to increases awareness about its products or services via a social networking system.

Word-of-mouth communications between consumers or potential consumers provides an important communication channel for businesses to increase brand awareness and grow a customer base. Because word-of-mouth communications not sponsored by a business or an advertiser, audiences often afford greater weight to word-of-mouth communication than paid advertisements. Hence, endorsement or criticism from word-of-mouth communications about a business may greatly influence the actions of other customers or potential customers regarding the business. The impact of word-of-mouth communications is increased in online environments like social networking systems where large audiences sharing similar interests are able to easily communicate with each other over potentially large geographic areas and wide demographic distributions. However, word-of-mouth communications are not easily tracked on a social networking system, making it difficult to a business to discern the effect of various word-of-mouth communications on potential customers or customers. For example, a business is currently unable to ascertain whether social networking system user has heard positive or negative information about a business or to ascertain the extent to which information heard by the user affects the user's interactions with the business.

### SUMMARY

To provide businesses with information describing communications through a social networking system regarding their products, services, or reputation, a social networking system identifies communications associated with a business distributed via the social networking system. For example, the social networking system identifies communications associated with an object maintained by the social networking system (e.g., a page, an image, a video, etc.) associated with the business. When communications associated with a business are identified, the social networking system determines the impact of those communications on various users of the social networking system. For example, the social networking system provides surveys about the business to users presented with a communication associated with a business, monitors subsequent communications by social networking system users presented with a communication associated with a business or not presented with a communication associated with the user.

Information describing the impact of communications associated with a business, or a “brand owner,” is provided to the business. In one embodiment, the social networking system organizes information describing the measured impact relationships between various social networking system users and communications associated with a business. For example, information describing the impact of communications associated by a business is identified for users who generated a communication associated with the business, users exposed to the communication associated with the business, and user not exposed to the communication associated with the business. In one embodiment, users that did not generate a communication associated with the business may be further categorized based on their similarity to a user generating the communication. For example, users that did not generate a communication associated with a business are categorized based the similarity of their user profiles to a user profile of a user that generated a communication associated with the business. Additionally, the information describing the impact of a communication associated with a business may variously weight the impact of a communication associated with a business on users based on connections between various users and a user that generated the communication. For example, the impact of communications on users directly connected to a user that generated a communication associated with a business may be more heavily weighted than the impact on users that are indirectly connected to users that generated the communication associated with the business. The social networking system may also identify a sentiment from communications associate with a business (e.g., positive, negative, a degree of positivity or negativity, etc.) and organize information describing impact of a communication associated with a business based on the sentiments.

Based on the information describing the impact of communications associated with a business, the business may provide a request to the social networking system to present a response communication to users based on sentiment determined from communications associated with users. For example, the social networking system receives one or more rules for presenting a response communication to users based on the sentiment determined from communications associated with the users. This allows a business to provide communications to users that reinforce a positive impact or counteract a negative impact. Examples of response communications include apologies, discounts, advertisements, and promotions. In one embodiment, the social networking system generates a report describing the impact of the response communications on user behavior and sentiment to provide information about the effectiveness of the business rules.

### BRIEF DESCRIPTION OF THE DRAWINGS

FIG. 1 is a block diagram of a system environment in which a social networking system operates, in accordance with an embodiment of the invention.

FIG. 2 is a block diagram of a social networking system, in accordance with an embodiment of the invention.

FIG. 3 is a flow chart of a method for measuring the impact of a communication on a social networking system associated an object associated with a brand owner, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system tracks communications relating to objects associated with a brand owner, also referred to as a “business”) and maintained by the social networking system. The social networking system measures the impact of these communications on user behavior or sentiment. Example communications relating to an object associated with a brand owner include communications in which an object (e.g., a status update, photo, or other content) relating to a brand owner, its products or services is tagged. Users associated with a communication relating to an object associated with a brand owner are categorized based on their relationship with the communication. Examples of categories include users who generated a communication (“content generators”), users who viewed the communication (“exposed users”), and users who did not view the communication (“unexposed users”). In some embodiments, exposed and unexposed users may be further categorized based on whether they have user profile information or performed actions similar to that of a content generator. Additionally, a sentiment towards the brand owner or towards the object associated with the brand owner may be determined from communications relating to an object associated with the brand owner and used to categorize users associated with the communications. For example, users associated with communications relating to brand owners may be categorized into broad groups, such as positive or negative, or into more narrow groups that are defined by a degree of positivity or negativity.

The social networking system measures the impact of a communication on various users associated with a communication relating to an object associated with a brand owner. For example, the social networking system determines the impact of a communication on content generators, exposed users, and unexposed users. Various methods may be used to determine the impact of a communication on social networking system users. For example, the social networking system presents surveys to users requesting information about the users' impressions of a brand owner or an object associated with the brand owner to determine the impact of communications regarding an object associated with the brand owner. In various embodiments, the social networking determines the impact of communications regarding an object associated with a brand owner by monitoring actions performed by users after presentation of a communication regarding an object associated with a brand owner (e.g., a number of interactions by a user with the object or an object associated with the brand owner, an amount spent by the user on products or services associated with the brand owner, communications between users, etc.) or by any other suitable method. An impact report describing the measured impact of the communications on social networking system users may be presented to the brand owner associated with the object. In one embodiment, the impact report is organized by the sentiment determined from various communications (e.g., positive, negative, or any other sentiment) and/or user type (e.g., content generators, exposed users, unexposed users, etc.).

The impact of various communications on exposed users may be weighted by relationships between various exposed users and a content generator. For example, the impact of a communication relating to an object associated with a brand owner on exposed users directly connected to a content generator may be more heavily weighted than the impact of the communication relating to the object associated with the brand owner on exposed users with no connection or with an indirect connection to the content generator. Additionally, the impact report may identify users having a threshold similarity with a content generator (“lookalike users”). For example, a lookalike user has performed a threshold number of actions with an object that is similar to an object associated with a communication generated by a content generator or has a threshold amount of user profile information matching, or similar to, user profile information associated with a content generator. In various embodiments, lookalike users may be identified based user profile information, actions performed on the social networking system and/or one or more third party systems, geographic location, connections to additional users, or other information similar to information associated with a content generator.

Based on the impact report, a brand owner may request the social networking system provide one or more response communications based at least in part on a sentiment associated with communications relating to an object associated with the brand owner. The response communications allow the brand owner to reinforce positive impacts or to counteract negative impacts of one or more communications relating to the object associated with the brand owner. For example, the social networking system receives one or more business rules from the brand owner identifying one or more response communications for presentation to a user based on a sentiment determined from one or more communications associated with the user that are related to an object associated with the brand owner. Examples of response communications include messages, offers, discounts, promotions, etc. A response report describing the effectiveness of response communications may be provided to the brand owner by the social networking system.

### System Architecture

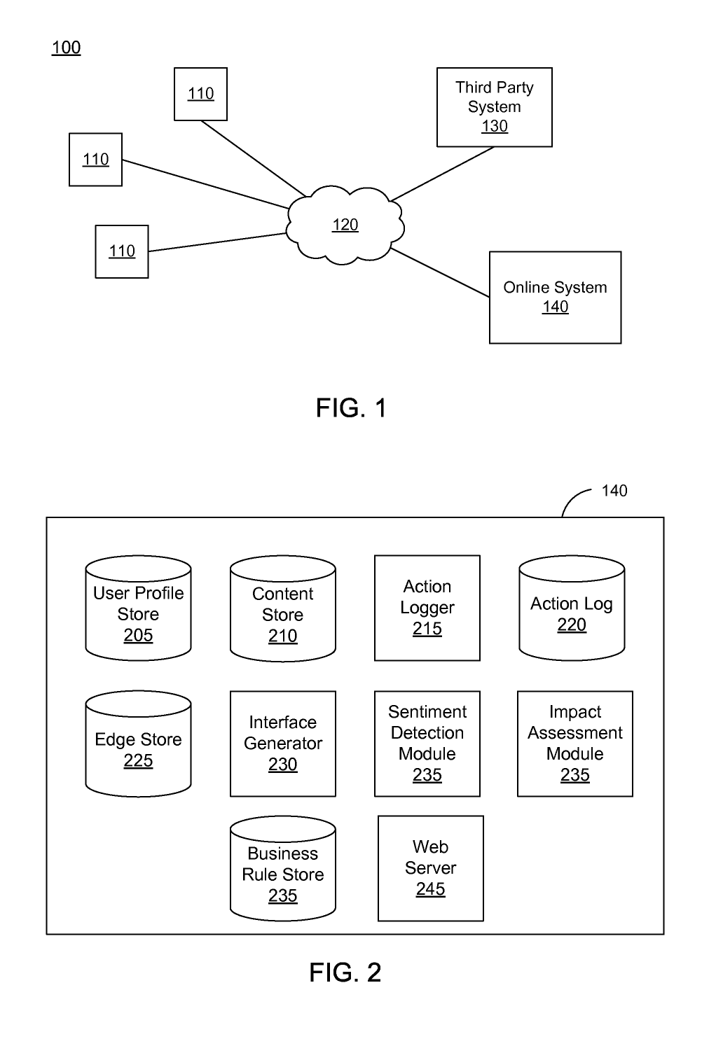

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. For example, the online system 140 is a social networking system. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130.

FIG. 2 is an example block diagram of an architecture of the social networking system 140. The social networking system 140 shown in FIG. 2 includes a user profile store 205, a content store 210, an action logger 215, an action log 220, an edge store 225, an interface generator 230, a sentiment detection module 235, an impact assessment module 240, a business rules store 245, and a web server 250. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, social networking system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, coworkers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The interface generator 230 generates one or more interfaces, such as web pages, including content from the online system 140. For example, interfaces generated by the interface generator 230 include images, video, profile information, or other data. The interface generator 230 also generates one or more interfaces allowing the online system 140 to request information from users and for users to provide information to the online system 140 via the client device 110 and the network 120. For example, the interface generator 230 generates a form for a user to provide biographic information, such as the user's age, for inclusion in the user's user profile. When other users request a user's profile page, the interface generator 230 retrieves data from the profile store 205 and generates a representation of the information in the user profile for presentation by the client device 110.

The interface generator 230 may also generate a composer interface allowing a user to create and post content on the social networking system 140. For example, the composer interface allows a user to create a content item when checking into a location; the content item may be posted to the user's profile page or included in a story presented to other users connected to the user. The interface generator 230 may generate stories and/or notifications describing actions performed by a user (e.g., installing an application, purchasing a product, etc.), which are presented to users connected to the user performing the action through a newsfeed, a timeline, or another suitable communication channel. Additionally, the interface generator 230 generates a survey for presentation to a user to assess the user's sentiments or actions related to a brand owner. For example, if the social networking system 140 receives a communication from a user about an object associated with a brand owner, the interface generator 230 generates a survey requesting information from the user about its impressions of the brand owner, about recent purchases by the user of the brand owner's products or services, recent visits by the user to a location associated with the brand owner, or other suitable information.

The social networking system 140 includes a sentiment detection module 235, which identifies one or more sentiments towards an object or a brand owner associated with the object from a communication relating to an object that is associated with a brand owner and maintained by the social networking system 140. To identify sentiments associated with communications, the sentiment detection module 235 determines a topic associated with a communication by identifying anchor terms included in a communication and determines a meaning of the anchor terms as further described in U.S. application Ser. No. 13/167,701, filed Jun. 24, 2011, which is hereby incorporated by reference in its entirety. Alternatively, a topic associated with a communication may be determined from tags or other structured data associated with a communication. In some embodiments, the topic associated with a communication is used to identify an object stored in the content store 210. The sentiment detection module 235 uses text-parsing technology and/or structured data to identify one or more sentiments from content included in a communication and associates the identified one or more sentiments with the topic or object associated with the communication. The sentiment detection module 235 may identify one or more sentiments associated a communication by prompting a user that generated the communication to provide additional information; for example, a survey or a selectable list of sentiments is presented to a user providing a communication related to an object associated with a brand owner. Based on a sentiment determined from various communications, the sentiment detection module 235 categorizes communications. For example, communications are categorized as positive or negative or into categories defined by different degrees of positivity or negativity. In other embodiments, any suitable sentiment may be determined for communications and used to categorize communications.

In one embodiment, the one or more sentiments associated with an object are stored by the social networking system 140 and associated with an object identifier corresponding to the object. Associations between object identifiers and sentiments may be stored in the content store 210 to simplify retrieval of one or more sentiments associated with an object identifier or retrieval of object identifiers associated with a specified sentiment; however, in other embodiments, associations between object identifies and sentiments are stored in any suitable component of the social networking system 140. Structured information associated with an object may also be used to retrieve a sentiment associated with the object.

The impact assessment module 240 measures the impact of a communication related to an object associated with a brand owner on activities by social networking system users affecting a brand owner's business. The measured impact may be associated with a communication provided to social networking system users from another social networking system user or from a communication provided to social networking system users from a brand owner or an advertiser. In one embodiment, the impact may be measured for users with different associations with communications related to an object associated with a brand owner. For example, the impact assessment module 240 generates an impact report describing the impact of one or more communications on content generators, exposed users, and unexposed users through any suitable method. The impact assessment module 240 may provide a survey to users associated with a communication related to an object associated with a brand owner (e.g., users generating a communication, users exposed to a communication, users not exposed to a communication) to determine the sentiments or actions related to a brand owner by various users. For example, a survey is presented to users after distribution of a communication related to an object associated with a brand owner asking for their impressions about a brand owner and responses to the survey are used to determine the impact of the presented communication. As another example, the impact assessment module 240 captures actions performed by users after presentation of a communication related to an object associated with a brand owner and analyzed to determine the impact of the communication. Examples of captured actions include purchases of a product or service associated with the brand owner after presentation of the communication, total amount of money spent on products or services associated with the brand owner after presentation of the communication, number of interactions with an object associated with the brand owner after presentation of the communication, number of visits to a location associated with the brand owner after presentation of the communication, number of installations of applications associated with the brand owner after presentation of the communication, and additional communications associated with the brand owner received after presentation of the communication. For example, if users are not exposed to a negative communication about a brand owner, the sentiments of the users' subsequent communications about the brand owner may be compared to the sentiment of users exposed to the negative communication and having a threshold number of similar characteristics in their user profiles as users not exposed to the negative communication. As another example, the impact assessment module 240 monitors the number of pages or products associated with a brand owner or the number of visits to a website associated with a brand owners by users having different associations with a communication relating to an object associated with a brand owner. In one embodiment, at least some information about user actions is received from the brand owner.

The business rule store 245 stores business rules or other data for identifying social networking system users to receive response communications based on sentiment determined from user-generated communications related to an object maintained by the social networking system 140 and associated with a brand owner. Examples of response communications include apologies, discounts, advertisements, coupons, credits, etc. The business rules may be provided to the social networking system 140 by a brand owner based on an impact report describing the impact of various communications related to an object associated with the brand owner on various users. The type of response communication sent to a user may be based on the sentiment associated with user-generated communications relating to an object associated with a brand owner (e.g., positive, negative, neutral, slightly negative, etc.) and/or based on categories associated with the user (e.g., content generators, exposed users, unexposed users, look-alike users, etc.). While described with reference to business rules, in various embodiments, the business rule store 245 includes any suitable information received from a brand owner requesting presentation of a response communication based at least in part on a sentiment determined from communications associated with the user. Examples of business rules for sending a targeted communication to a user associated with one or more communications having a negative sentiment include sending an apology, a discount, an upgrade, a promotion, and/or a targeted advertisement (e.g., an advertisement about improvements to services, amenities, etc.). Examples of business rules for sending a targeted communication to a user associated with one or more communications having a positive sentiment include soliciting an online review for positive feedback and sending a targeted advertisement (e.g., an advertisement for new promotions or products, loyalty programs, etc.).

The web server 250 links the social networking system 140 via the network 120 to the one or more client devices 110, as well as to the one or more third party systems 130. The web server 250 serves web pages, as well as other web-related content, such as JAVA®, FLASH®, XML and so forth. The web server 250 may receive and route messages between the social networking system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that is stored in the content store 210. Additionally, the web server 250 may provide application programming interface (API) functionality to send data directly to native client device operating systems, such as IOS®, ANDROID™, WEBOS® or RIM®.

### Measuring Communication Impact

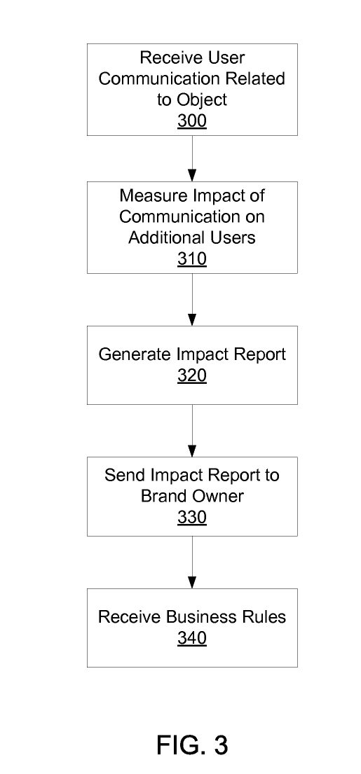

FIG. 3 is a flow chart of one embodiment of a method for measuring the impact of a communication on a social networking system 140 relating to an object associated with a brand owner. The social networking system 140 receives 300 a communication from a user (a “content generator” as the user creates the communication) of the social networking system 140 about an object maintained by the social networking system 140 and associated with a brand owner. The communication may include any information provided by the user and associated with the object maintained by the social networking system 140 (e.g., check-ins, page posts, status updates, etc.). The communication may include one or more tags identifying the object associated with the brand owner, or an object related to the communication may be identified through text-parsing the content of the communication or through any other suitable technique. The social networking system 140 may also determine a sentiment associated with the communication through text-parsing methods, retrieving structured data associated with the communication, providing a survey or other request to the user from which the communication was received, or using any other suitable method. The sentiment may determine if the communication is positive, negative, or any other suitable classification of the communication.

The social networking system 140 presents the received communication to one or more social networking system users and determines 310 an impact of the communication on additional social networking system users. Surveys may be presented to users after presentation of the received communication to one or more users and responses received from various users determine 310 the impact of the communication. In other embodiments, actions (e.g., purchases from the brand owner, communications associated with the brand owner, accesses of objects associated with the brand owner, etc.) performed by users after presentation of the communication to one or more users are identified and analyzed to determine 310 the impact of the communication.

Associations between various users and the received communication are determined. For example, the user from which the communication is received is identified as a “content generator,” users presented with the communication are identified as “exposed users,” and users not presented with the communication are identified as “unexposed users.” An impact report describing the impact of the communication on social networking system users with respect to the brand owner is generated 320 from the measured impact and from the associations between the various users and the received communication. For example, the impact report is organized by user category (e.g., content generator, exposed users, unexposed users, lookalike users, etc.) and/or the sentiment of the communication (e.g., degree to which the communication was positive or negative). For example, information in an impact report about the determined impact of a negative communication about a type of computer includes the received communication, the sentiment associated with the communication (e.g., a degree of negativity), statistics regarding sales of the product or other products associated with the same brand (e.g., a number of computers purchased by additional users, a number of electronics products purchased by additional users, etc.), and subsequent communications about the brand of the computer by additional users. The information in the impact report may also indicate relationships between the additional users and the user from which the communication was received and similar characteristics or actions between additional users and the user from which the communication was received.

Alternatively, the measured impact is represented using a score indicating the magnitude of the communication's impact on additional social networking system users. A range of scores indicating the magnitude of impact of a communication may represent the impact in terms of sentiment. For example, impact is measured on a scale of zero to ten, where a communication having an impact with a score less than two has negligible impact on additional users of the social networking system 140, while a communication having an impact with a score greater than seven has a major positive impact or negative impact on social networking system users. Determined impacts on additional users may be variously weighted based on the relationships between additional users and the user from which the communication was received. For example, if a status update about a particular car model is received from a content generator, subsequent communications about the car manufacturer from users connected to the content generator (e.g., friends, family, coworkers, etc.) are more heavily weighted than communications from users not connected to the content generator when determining the impact of the status update.

The impact report is sent 330 to the brand owner associated with the object associated with the communication. Information about brand owners associated with the object may be retrieved from the content store 210. In one embodiment, more than one brand owner is associated with the object, and the impact report is sent 330 to the various brand owners.

In one embodiment, the social networking system 140 receives 340 a request from a brand owner identifying a response communication for presentation to one or more users associated with the received communication. For example, the social networking system receives 340 one or more business rules from the brand owner identifying a response communication for presentation to one or more users associated with the received communication based at least in part on the sentiment associated with the received communication. The brand owner may base the request on information from the impact report. For example, the request received 340 from the brand owner identifies a response communication for presentation to a user based on an association between the user and the communication (e.g. content generators, exposed users, unexposed users, lookalike users, etc.). In some embodiments, response communications for presentation to users connected to a content generator are targeted based on a type of connection to the content generator. For example, users directly connected to a content generator are targeted to receive a response communication from a brand owner while users with indirect connections to the content generator are not targeted to receive a response communication.

Users may be further targeted for receiving response communications based on their association with a brand, category of product, or location. For example, a brand owner that manufactures a beer may target users for receiving a response communication based on the users' purchases of a particular brand of beer, the users' purchases of any types of beer, or the users' visit to a particular brewery. Additionally, users may be targeted for receiving a response communication based on the predicted impact of the response communication on the users. For example, if a content generator provides a communication including a check-in at a hotel and a complaint about the hotel and the social networking system 140 determines that an additional user connected to the content generator has a history of check-ins to the same location at the same time, the social networking system 140 sends the additional user a response communication based on a request received from the brand owner associated with the hotel. Because of the connection between the content generator and the additional user, the response communication is more likely to affect the additional user than a user that is not exposed to the communication from the content generator.

Hence, the received request from a brand owner determines the type of response communication sent to social networking system users based on the generated impact report. In one embodiment, the sentiment determined from communications relating to an object associated with a brand owner and the association between various users and the communications is used to determine the response communication sent to various users. For example, users associated with a communication having a negative sentiment (e.g., users generating the communication or users exposed to the communication), the brand owner may send apologies, discounts, promotions, and advertisements informing users of improvements or changes made by the brand owner. As another example, for users associated with a communication having a positive sentiment (e.g., users generating the communication or users exposed to the communication), the brand owner may request the social networking system 140 send communications requesting online reviews, requesting positive feedback, or presenting advertisements notifying users of new promotions, products, or services.

### Application of Business Rules and Measuring Effectiveness of Brand Owner Response

The social networking system 140 may measure the impact of response communications sent to users based on business rules or requests received by the social networking system 140 from a brand owner. In one embodiment, the social networking system 140 generates a response report indicating the effectiveness of various response communications sent to users in reinforcing a positive impact or in counteracting a negative impact from a user-generated communication and sends the response report to a brand owner. The impact of a response communication on users may be determined using similar methods as those described above in conjunction with FIGS. 2 and 3 for determining the impact of a communication received from a user. Similarly, the impact of a response communication may be weighted based on connections between various users and the user from which a user-generated communication causing presentation of a response communication, as described above. The response report sent to a brand owner may be organized based on associations between various users and a communication received from a social networking system and relating to an object associated with the brand owner causing presentation of a response communication (e.g., content generator, exposed users, unexposed users, lookalike users, etc.).

In one embodiment, the social networking system 140 uses the response report and one or more machine-learning methods to predict the effectiveness of different types of response communications sent to users with various associations to user-generated communications. For example, the response report indicates that presenting apologies or discounts to respond to a content generator of a communication with a negative impact are most effective at counteracting the negative impact while presenting advertisements for new products to users exposed to a communication with a positive impact are most effective at reinforcing the positive impact. Users may be designated to receive response communications from a brand owner based on a combination of the predicted effectiveness of different types of response communications on the users as well as requests or business rules received 340 from the brand owner. For example, if a business rule received 340 from a brand owner requests the social networking system 140 send an apology or a discount to a content generator of a communication with a negative impact and a machine-learning module determines a discount will be more effective than an apology, the social networking system 140 sends a discount rather than an apology.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving one or more communications from a user of a social networking system identifying one or more objects maintained by the social networking system associated with a brand owner;
determining an impact of each of the communications on one or more additional users of the social networking system, the impact based on actions by one or more additional users identified by the social networking system and associated with an object identified by a received communication;
determining one or more groups of users based at least in part on exposure to a received communication by one or more additional users;
generating a report based on the determined impact of each of the communications and the one or more groups of users, the report describing the impact of the one or more communications on the one or more groups of users; and
sending the report for presentation to the brand owner.

2. The method of claim 1, wherein receiving one or more communications from a user of a social networking system identifying one or more objects maintained by the social networking system associated with a brand owner comprises:
receiving one or more communications from the user of the social networking system identifying one or more objects associated with the brand owner;
determining a sentiment associated with one or more of the received communications.

3. The method of claim 2, wherein the sentiment associated with a received communication is selected from a group consisting of: a positive sentiment, a negative sentiment, and a neutral sentiment.

4. The method of claim 2, wherein determining the sentiment associated with one or more of the received communications comprises:
parsing text content included in a received communication; and
determining the sentiment of the received communication based at least in part on the parsed text content.

5. The method of claim 2, wherein determining the sentiment associated with one or more of the received communications comprises:
retrieving structured data associated with a received communication; and
determining the sentiment of the received communication based at least in part on the structured data.

6. The method of claim 1, wherein determining the impact of each of the communications on one or more additional users of the social networking system comprises:
identifying a communication of an additional user of the social networking system after the additional user received a communication from the user identifying an object associated with the brand owner; and
determining a sentiment associated with the object from the communication of the additional user of the social networking system.

7. The method of claim 1, wherein determining the impact of each of the communications on one or more additional users of the social networking system comprises:
providing a survey to an additional user of the social networking system that received a communication from the user identifying an object associated with the brand owner;
receiving a response to the survey from the additional user of the social networking system that received the communication from the user identifying the object associated with the brand owner; and
determining a sentiment associated with the brand owner from the response to the survey.

8. The method of claim 1, wherein determining the impact of each of the communications on one or more additional users of the social networking system comprises:
identifying an action by an additional user of the social networking system after the additional user received a communication from the user identifying an object associated with the brand owner; and
determining a sentiment associated with the object from the communication of the additional user of the social networking system based on the action.

9. The method of claim 8, wherein the action by the additional user of the social networking system comprises a purchase associated with the brand owner.

10. The method of claim 1, wherein determining one or more groups of users based at least in part on exposure to the received communication by one or more additional users comprises:
identifying the user from which the one or more communications were received;
identifying one or more additional users receiving at least one of the one or more communications; and
identifying one or more additional users that did not receive at least one of the one or more communications.

11. The method of claim 1, wherein determining one or more groups of users based at least in part on exposure to the received communication by one or more additional users comprises:
identifying one or more additional users that received at least one communication from the one or more communications and having a threshold similarity with the user from which the one or more communications were received.

12. The method of claim 11, wherein an additional user having the threshold similarity with the user from which the one or more communications were received is selected from a group consisting of: additional users having a connection to the user from which the one or more communications were received, additional users having a threshold amount of user profile information similar to user profile information of the user from which the one or more communications were received, additional users having performed a threshold number of actions similar to actions performed by the user from which the one or more communications were received, and any combination thereof.

13. The method of claim 1, wherein determining the impact of each of the communications on one or more additional users of the social networking system comprises:
generating a score for each communication indicating a magnitude of the impact on the one or more additional users of the social networking system.

14. The method of claim 1, wherein generating the report based on the determined impact of the received communication on the one or more additional users of the social networking system presented with the received communication comprises:
determining a sentiment for the brand owner from one or more of the communications;
generating the report based at least in part on the determined sentiment and on the impact of the one or more communications on the one or more groups of users.

15. A method comprising:
receiving a request to determine an impact on users of a social networking system of one or more communications associated with one or more objects maintained by the social networking system and associated with a brand owner;
receiving a communication from a user of the social networking system for presentation to one or more additional users of the social networking system;
determining whether the received communication identifies at least one of the one or more objects maintained by the social networking system and associated with the brand owner;
determining an impact of the received communication on one or more additional users of the social networking system presented with the received communication if the received communication identifies at least one of the one or more objects maintained by the social networking system and associated with the brand owner;
generating a report based on the determined impact of the received communication on the one or more additional users of the social networking system presented with the received communication; and
sending the report for presentation to the brand owner.

16. The method of claim 15, wherein determining whether the received communication identifies at least one of the one or more objects maintained by the social networking system and associated with the brand owner comprises:
determining whether the received communication includes a tag associated with the one or more objects.

17. The method of claim 15, wherein determining whether the received communication identifies at least one of the one or more objects maintained by the social networking system and associated with the brand owner comprises:
determining a sentiment towards the brand owner responsive to determining the received communication identifies at least one of the one or more objects maintained by the social networking system and associated with the brand owner.

18. The method of claim 15, wherein determining the impact of the received communication on one or more additional users of the social networking system presented with the received communication comprises:
identifying a communication of an additional user of the social networking system after the additional user was presented with the received communication; and
determining a sentiment associated with an object associated with the communication of the additional user of the social networking system.

19. The method of claim 15, wherein determining the impact of the received communication on one or more additional users of the social networking system presented with the received communication comprises:
providing a survey to an additional user of the social networking system presented with the received communication;
receiving a response to the survey from the additional user of the social networking system that received the communication from the user identifying an object associated with the brand owner; and
determining a sentiment associated with the brand owner from the response to the survey.

20. The method of claim 15, wherein determining the impact of the received communication on one or more additional users of the social networking system presented with the received communication comprises:
identifying an action by an additional user of the social networking system presented with the received communication; and
determining a sentiment associated with an object identified by the received communication based on the action.
